(19) United States
(12) Patent Application Publication
(10) Pub. No.: US 2015/0058043 A1
(43) Pub. Date: Feb. 26, 2015

(54) SYSTEMS AND METHODS FOR A REHABILITATION DASHBOARD

(71) Applicant: Rehabilitation Institute of Chicago, Chicago, IL (US)

(72) Inventors: Allen W. Heinemann, Chicago, IL (US); Sara Jerousek, Chicago, IL (US); James Sliwa, Chicago, IL (US); Eileen French, Chicago, IL (US); Elizabeth Garcia, Chicago, IL (US); Mark Thomas, Chicago, IL (US); Tim McKula, Chicago, IL (US); Tom Snyder, Chicago, IL (US); Mary Henry, Chicago, IL (US); Konrad Kording, Chicago, IL (US); Mark Albert, Chicago, IL (US)

(21) Appl. No.: 14/468,051

(22) Filed: Aug. 25, 2014

Related U.S. Application Data
(60) Provisional application No. 61/869,472, filed on Aug. 23, 2013.

(51) Int. Cl. G06F 19/00; G06F 3/0484

(52) U.S. Cl. CPC G06F 19/322; G06F 3/0484
USPC 705/3

(57) ABSTRACT

A rehabilitation dashboard system and method for the display of information relating to the treatment and care of a patient in a rehabilitation setting is disclosed.

### CROSS REFERENCE TO RELATED APPLICATIONS

The present application claims benefit to U.S. provisional patent application Ser. No. 61/869,472 filed on Aug. 23, 2013 and is herein incorporated by reference in its entirety.

### FIELD

The present document relates to systems and methods for a rehabilitation dashboard, and in particular to a rehabilitation dashboard for use of patient data in the field of physical medicine and rehabilitation.

### BACKGROUND

Physical medicine and rehabilitation (“PM&R”) is a branch of medicine focused on enhancing and restoring the functional ability and quality of life to individuals with physical impairments or disabilities. PM&R clinicians serve wide range of patient populations, including patients with pulmonary disease, heart failure, stroke, spinal cord injury, geriatrics, fibromyalgia, multiple sclerosis, and Parkinson's disease. Clinicians in the PM&R field include physicians, speech therapists, occupational therapists, psychologists, social workers, and nurses. PM&R clinicians utilize a variety of measures to assess patient outcomes in different areas of rehabilitation, such as physical therapy or nursing. Various tools for measuring health outcomes are also known in the different areas of the field of rehabilitation.

Existing software programs allow for the retrieval and display of data stored in databases. One such software program is Dundas Dashboard from Dundas Data Visualization, Inc. (Toronto, Calif.), a web-based platform that enables users to create their own dashboards that pull data from different databases.

### SUMMARY

Herein is described a rehabilitation dashboard system and method for the display of information relating to the treatment and care of a patient in a rehabilitation setting.

### BRIEF DESCRIPTIONS OF THE DRAWINGS

FIG. 1 illustrates one embodiment of a main outcomes page of the dashboard system.

FIG. 2 illustrates another embodiment of a main outcomes page of the dashboard system.

FIG. 3 illustrates one embodiment of a main outcomes page and multiple detail outcomes pages of the dashboard system.

FIG. 4 illustrates one embodiment of the detail outcomes page of the dashboard system for postural stability and gait measures.

FIG. 5 illustrates activity levels of a patient collected from a personal computing device worn by the patient.

FIG. 6 illustrates a graph of patient activity levels that may be displayed on a main outcomes page or on another page.

FIG. 7 illustrates one embodiment of the data sources from which data may be obtained for display on a dashboard page.

Corresponding reference characters indicate corresponding elements among the view of the drawings. The headings used in the figures should not be interpreted to limit the scope of the claims.

### DETAILED DESCRIPTION

One aspect of the embodiments of the dashboard system described herein is that it simplifies the clinical discussion and reporting of patient outcomes. Using embodiments of the dashboard system, clinicians, patients and others can monitor clinician-documented outcomes, patient-reported outcomes, a patient's activity level, and other measures in a single display.

Another aspect of the dashboard system described herein is that the rehabilitation data displayed on the dashboard is received in response to a query to the patient medical record in an electronic health record (“EHR”) or other existing data sources, thereby allowing the displayed data to be updated automatically as additional information is collected and entered into the EHR.

Another aspect of the dashboard system described herein is that in various embodiments, research data, clinical data, and patient data are all integrated into a single rehabilitation dashboard.

In one embodiment, the system includes an main outcomes page that displays measurements from a plurality of different disciplines, including physical medicine and rehabilitation, nursing, physical therapy, occupational therapy, speech language pathology, and research.

One section of the main outcomes page may display patient information. Patient information may include rehabilitation measures such as estimated discharge data, financial class, clinical service, isolation status, Morse Fall Scale, and FIM scores and goals. Another section of the main outcomes page may display nursing information. Nursing information may include rehabilitation measures such as pain level, sleep, and bowel and bladder functions. Another section of the main outcomes page may display physical therapy information. Physical therapy information may include rehabilitation measures such as the Berg Balance, Sit-to-Stand, Gait Speed, and Six Minute Walk tests, along with selected FIM items. Another section of the main outcomes page may display occupational therapy information, including selected occupational therapy measures. Another section of the main outcomes page may display speech language pathology information, including selected speech language pathology measures. Another section of the rehabilitation home page may display patient-reported outcomes information. Patient-reported outcomes information may include measures from a patient-reported measures (PROMIS) instrument, such as depression, fatigue, pain interference, positive and negative psychosocial impact of illness, or sleep disturbance. Another section of the main outcomes page may display patient activity level information. Data from the patient activity level may be generated from an accelerometer worn or otherwise used by a patient.

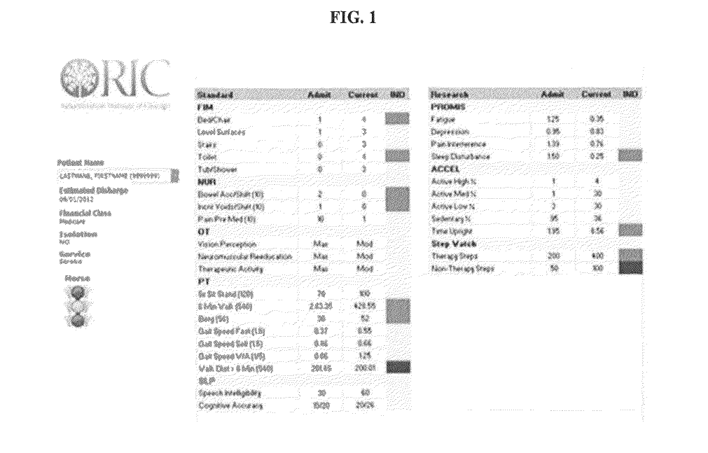

FIG. 1 displays one embodiment of a main outcomes page. The main outcomes page summarizes various measures relating to the area of clinical discipline or research relevant to a patient in a rehabilitation setting. On the main outcomes page, measures are arranged in different rehabilitation categories to enable quick and accurate review by clinicians while providing care. In the embodiment of the main outcomes page displayed in FIG. 1, the rehabilitation categories include functional improvement (FIM), nursing (NUR), occupational therapy (OT), physical therapy (PT), speech language therapy (SLP), patient-reported measures (PROMIS), acceleration, and step watch. The main outcomes page may be displayed on a personal computer, a tablet, a smartphone, a television monitor, specialized clinical monitors, or another electronic display.

Specific measures related to that rehabilitation category are displayed under each rehabilitation category. For instance, under the SLP category, “speech intelligibility” and “cognitive accuracy” measurements are displayed. Next to each measurement are one or more values that reflect a patient's score in that measurement. In the embodiment displayed in FIG. 1, there are two values next to each measurement: Admit and Current. Admit reflects the value of a measurement upon or soon after patient admission (e.g., admission information), while Current reflects the most recent value of that measurement. In one embodiment, the Admit and Current values could be raw values that are entered into a medical record. In another embodiment, the values could be normalized. For instance, values could be normalized from 0 (lowest possible score) to 100 (highest possible score) for each day of assessment through an episode of care. For example, the original range for pain ratings is 0 to 10; thus, a normalized value of 50 corresponds to an original score of 5. For the Berg Balance Test, the original scale is 0-56; thus, a normalized value of 60 corresponds to an original score 34 (56×60%).

In yet another embodiment, both normalized and natural values could be shown. Also displayed near each measurement listing is an indicator that is used to compare the Current value in that measurement to the Admit value. In one embodiment, the indicator may be different colors, including green, yellow, and red, to reflect different levels of patient improvement. As a result, a clinician (or team of clinicians) can quickly review the home page to focus on those measurements of clinical interest.

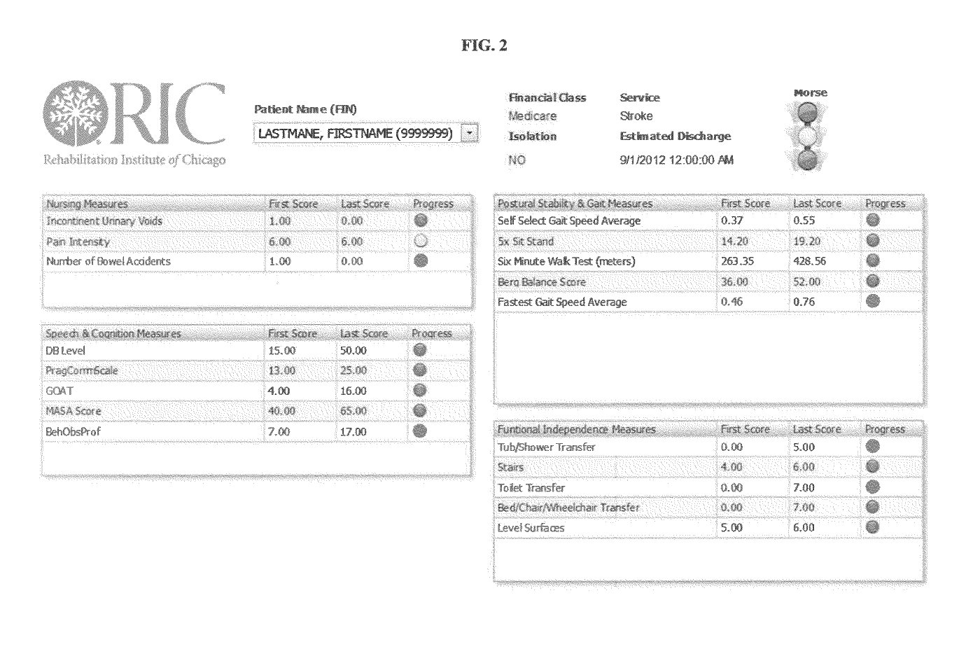

Another embodiment of the home page is displayed at FIG. 2. On the home page, rehabilitation categories include Nursing Measures, Speech & Cognition Measures, Postural Stability & Gait Measures, and Functional Independence Measures. The Nursing Measures category includes measures in Incontinent Urinary Voids, Pain Intensity, and Number of Bowel Accidents. The Speech & Cognition Measures category includes decibel level (“DB Level”), communication scale (“PragCommScale”), Galveston Orientation and Amnesia Test (GOAT), Mann Assessment of Swallowing Ability (“MASA Score”), and behavioral observation (“BehObsProf”). The Postural Stability & Gait Measures category includes measures in Self Select Gait Speed Average, 5× Sit Stand, Six Minute Walk Test, Berg Balance Score, and Fastest Gait Speed Average. The Functional Independence Measures category includes measures in Tub/Shower Transfer, Stairs, Toilet Transfer, Bed/Chair/Wheelchair Transfer, and Level Surfaces.

In the embodiment of the main outcomes page displayed in FIG. 2, each rehabilitation measure is displayed along with a First Score, a Last Score, and a Progress indicator. The First Score reflects the patient's initial values for a particular rehabilitation measurement and may be used by a clinician to establish a baseline value for the patient in that measurement. The Last Score reflects the patient's most recent values for a particular rehabilitation measurement and may be used by a clinician to determine the patient's progress to date in that measurement. The Progress indicator provides a quick way for a clinician to determine whether a patient is making appropriate progress in a rehabilitation measurement. In one embodiment, the indicator may be green, reflecting appropriate progress, or yellow or red, reflecting that attention is needed to the patient's improvement in this measurement.

In one embodiment of the main outcomes page, only rehabilitation measures that have one or more values are displayed. For instance, if the patient has not provided information to determine Pain Intensity values, then the Pain Intensity measure would not appear on the main outcomes page. In another embodiment of the main outcomes page, clicking on the rehabilitation category name or another column heading on a chart causes the chart to sort in increasing or decreasing order of the values in that column.

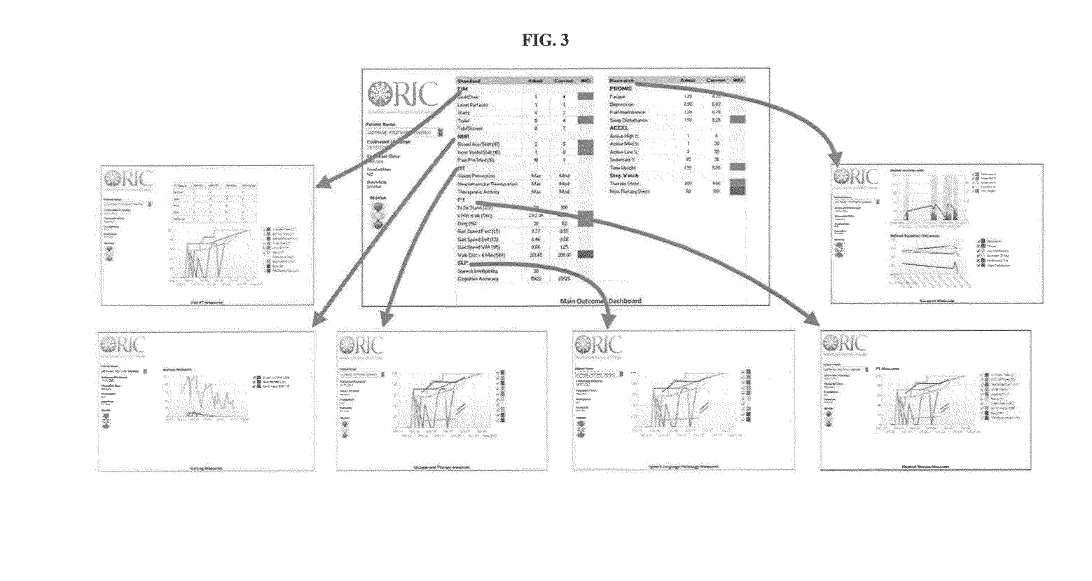

The title bar of each rehabilitation category is hyperlinked to open another page when clicked. When a user of the home page clicks on a category title (such as “PROMIS” or “SLP” shown in FIG. 1 or “Nursing Measures” in FIG. 2), an ability detail page is launched with information relating to that category. FIG. 3 displays embodiments of different detailed pages for each category of information. An ability detail page may include the patient's name, estimated discharge date, financial class, whether the patient is in isolation (due, for instance to a contagious disease), and a Morse fall scale indicator that indicates the patient's likely risk of falling. Each ability detail page may include at least one graph that displays values for one or more measurements in that category that have been collected during the patient's admission to the rehabilitation facility. Values are graphed over time and more than one measurement may be displayed on a graph. Graphs may be line graphs, bar graphs, or other graph displays. Multiple measurements may be plotted on the same graph. Measurements may be displayed in different colors so that clinicians can identify the plot on the graph that corresponds to a particular measurement.

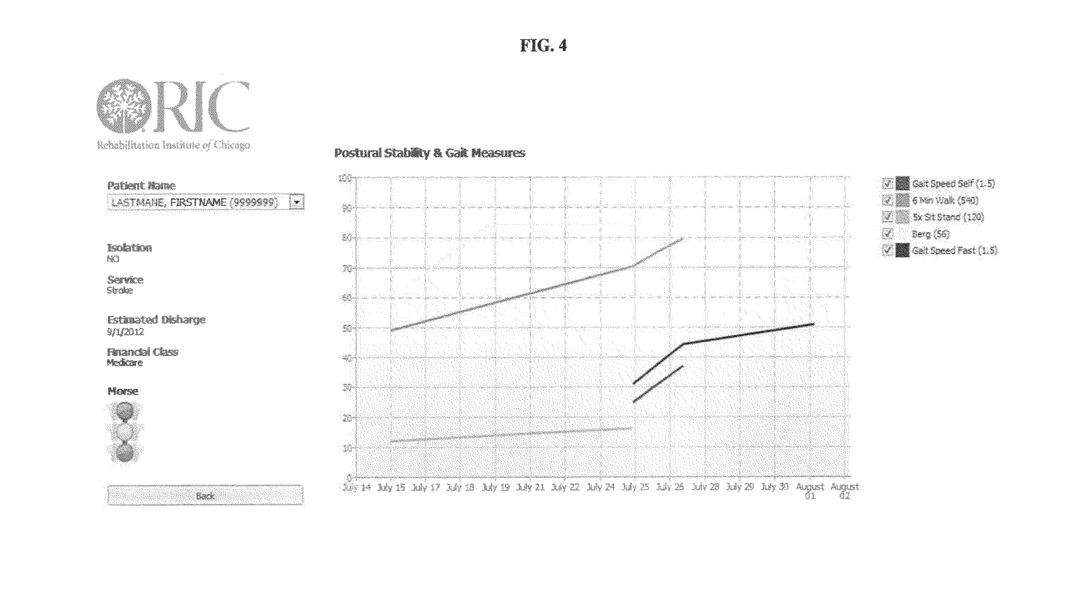

FIG. 4 displays an embodiment of the ability detail page for Postural Stability & Gait Measures. Along the left-hand side of the display, the patient name, isolation status, service, estimated discharge date, financial class, and Morse status are displayed. The graph displays values for different postural stability and gait rehabilitation measures collected during the patient's treatment, including gait speed, Six Minute Walk, 5× Sit Stand, and Berg Balance. In other embodiments of the ability detail page, other measures related to other rehabilitation categories may be displayed. On the ability detail page for nursing rehabilitation measures, values for rehabilitation measures such as bowel acc/shift, incnt voids/shift, and pain before medication (“pain pre med”) may be displayed. On the ability detail page for occupation therapy nursing measures, values for rehabilitation measures such as vision perception, neuromuscular reeducation, and therapeutic activity may be displayed. On the ability detail page for physical therapy measures, values for rehabilitation measures such as 5× Sit to Stand, the 6 Minute Walk, the Berg Balance, Gait Speed Fast, Gait Speed Self, Gait Speed W/A, and Walking Dist>6 Min may be displayed. On the ability detail page for physical therapy measures, values for speech language pathology, speech intelligibility and cognitive accuracy may be displayed. On the ability detail page for patient reported measures, values for fatigue, depression, pain interference, and sleep disturbance may be displayed. On the ability detail page for acceleration measures, active high %, active med %, active low %, sedentary %, and time upright may be displayed. On the ability detail page for step watch, values for therapy steps and non-therapy steps may be displayed.

Patient reported measures may include those reported by the PROMIS Computer Adapted Tests (CATs). In one embodiment, values for such measures are rescaled so that the average of the U.S. general population is 50 and its standard deviation (SD) is 10. Thus, a person who has a PROMIS score of 40 is one SD below the U.S. average. For negatively-worded concepts like fatigue, a T-score of 60 is one SD worse than average (more fatigue), and a score of 40 is one SD better than average (less fatigue). For positively-worded concepts like Positive Psychosocial Illness Impact, a score of 60 is one SD better than average. In one embodiment, PROMIS domains are assessed over the prior seven days.

Fatigue is one patient reported measure that may be displayed on a dashboard page. In one embodiment, fatigue is determined using the fatigue item bank from PROMIS, which evaluates a range of self-reported symptoms, from mild subjective feelings of tiredness to an overwhelming, debilitating, and sustained sense of exhaustion that likely decreases one's ability to execute daily activities and function normally in family or social roles. Fatigue is divided into the experience of fatigue (frequency, duration, and intensity) and the impact of fatigue on physical, mental, and social activities. The fatigue short form is generic rather than disease-specific. A fatigue T-score of 50 is average for the U.S. population, with a T-score of less than 50 reflecting less fatigue than average and a T-score of greater than 50 reflecting more fatigue than average.

Depression is another patient reported measure that may be displayed on a dashboard page. In one embodiment, depression is determined using the depression item bank from PROMIS, which assesses self-reported negative mood (sadness, guilt), views of self (self-criticism, worthlessness), and social cognition (loneliness, interpersonal alienation), as well as decreased positive affect and engagement (loss of interest, meaning, and purpose). Somatic symptoms, such as changes in appetite or sleeping patterns, are not included, which eliminates consideration of these items' confounding effects when assessing patients with comorbid physical conditions. A depression T-score of 50 is average for the U.S. population, with a T-score of less than 50 reflecting less depression than average and a T-score of greater than 50 reflecting more depression than average.

Sleep disturbance is another patient reported measure that may be displayed on a dashboard page. In one embodiment, sleep disturbance is determined using the sleep disturbance item bank from PROMIS, which assesses self-reported perceptions of sleep quality, sleep depth, and restoration associated with sleep. This includes perceived difficulties and concerns with getting to sleep or staying asleep, as well as perceptions of the adequacy of and satisfaction with sleep. Sleep disturbance does not focus on symptoms of specific sleep disorders, nor does it provide subjective estimates of sleep quantities (total amount of sleep, time to fall asleep, amount of wakefulness during sleep). The sleep disturbance short form is generic rather than disease specific. A sleep disturbance T-score of 50 is average for the U.S. population, with a T-score of less than 50 reflecting less sleep disturbance than average and a T-score of greater than 50 reflecting more sleep disturbance than average.

Pain interference is another patient reported measure that may be displayed on a dashboard page. In one embodiment, pain interference is determined using the pain interference item bank from PROMIS, which measures the self-reported consequences of pain on relevant aspects of the patient's life. This includes the extent to which pain hinders engagement with social, cognitive, emotional, physical, and recreational activities. Pain interference also incorporates items probing sleep and enjoyment in life. The pain interference short form is generic rather than disease-specific. A pain interference T-score of 50 is average for the U.S. population, with a T-score of less than 50 reflecting less pain interference than average and a T-score of greater than 50 reflecting more pain interference than average.

In one embodiment, fatigue, depression, sleep disturbance, and pain interference measures may be the only patient-reported measures reported on the rehabilitation dashboard. In other embodiments, additional measures may be utilized.

Embodiments of the system disclosed herein may display data collected by a personal computing device, such as a smartphone. In these embodiments, the personal computing device may comprise an accelerometer (a device that measures movement in three dimensions). When the patient moves, the accelerometer records those movements and stores them in memory of the patient computing device. Movement information may be collected by the accelerometer multiple times each second and is periodically transmitted to an accelerometer database. In one embodiment, the data is transmitted from the personal computing device to a secure server when a wireless connection, such as an 802.11b connection, is available.

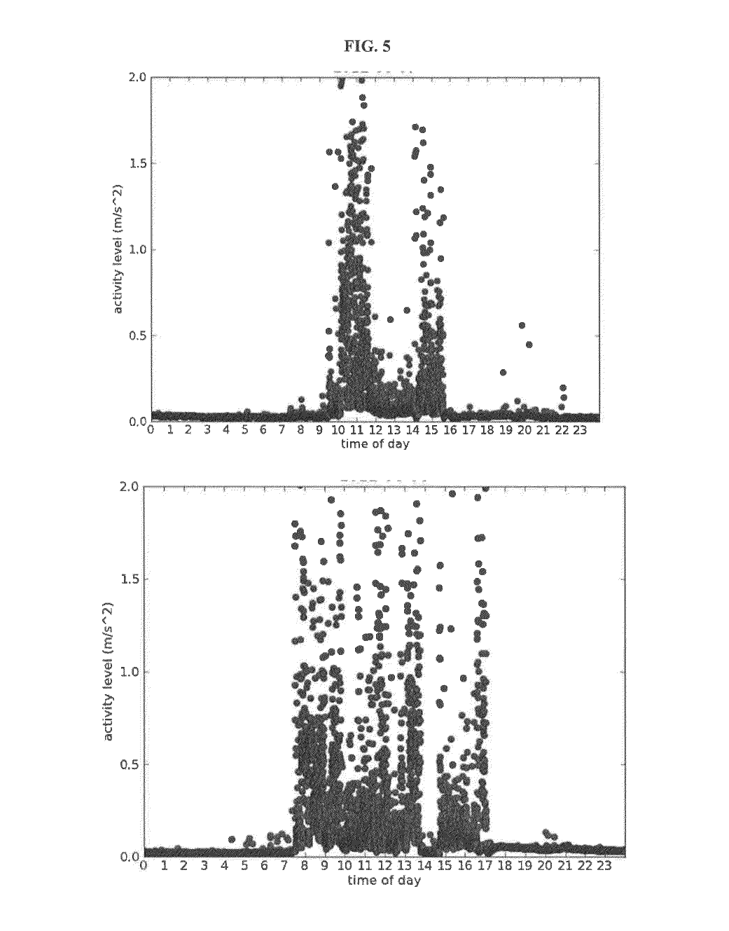

FIG. 5 displays activity plots of patient movement data collected on two different days. Each dot represents a 10 second interval during the day. The higher the dot's position on the graph, the more active the patient was during that interval.

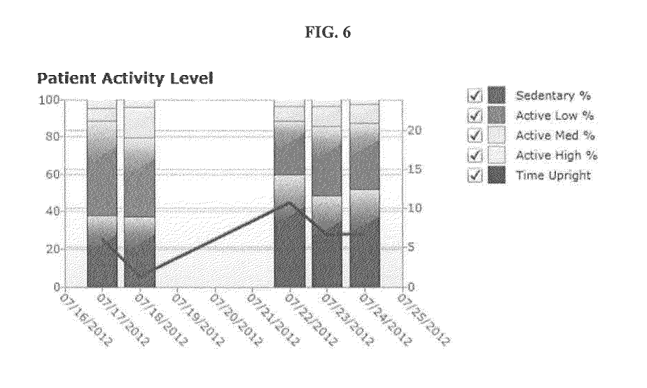

FIG. 6 displays one embodiment of how patient activity level may be displayed on the main outcomes page or an ability detail page. In this embodiment, data are categories into four activity levels: sedentary, low, medium, and high. The activity level plot summarizes how much the personal computing device—and thus the patient—moves over the course of a day. Collected activity includes orientation changes as well as abrupt movements of the phone. Table 1 lists examples of different activities and the category into which these activities fall. Activity level is listed as average acceleration change in m/s².

TABLE 1

| Type/Range of Movement | Activity Level |
|---|---|
| Sedentary | 0-0.1 |
| Standing | 0.05 |
| Low Activity | 0.1-0.5 |
| Standing or swaying | 0.25 |
| Medium Activity | 0.5-1.0 |
| Slow walk | 0.60 |
| High Activity | Greater than 1.0 |
| Fast walk | 1.32 |
| Repeated sit to stand | 2.09 |

It should be understood that the activity level values may change depending on the placement of the personal computing device on the patient. For instance, the personal computing device may be placed near a patient's torso, for instance on a belt. If so placed, certain activities like biking will not register with an equivalent level of activity, as the accelerometer in the personal computing device does not recognize the patient's lower-body movement. It may be appropriate for a clinician to readjust the position of the personal computing device for the system to accurately collect activity levels.

In FIG. 6, a bar representing a given day shows the percentage of that day spent in each of the activity levels. For instance, a patient spent 5% of her day in a high activity level, 5% of the bar for that day would be filled with a color reflecting a high activity level. In one embodiment, the bar is colored tan for a high level of activity, light blue for a medium level of activity, green for a low level of activity, and dark blue for sedentary activity. Additionally, Time Upright data may be charted across the daily graphs. The line on the Time Upright plot represents the total number of hours of data collected by the personal computing device for analysis on a particular day. If the line is relatively low, it can be an indication to the clinician that the analysis for that day may be less reliable, since it was derived from less data than on other days.

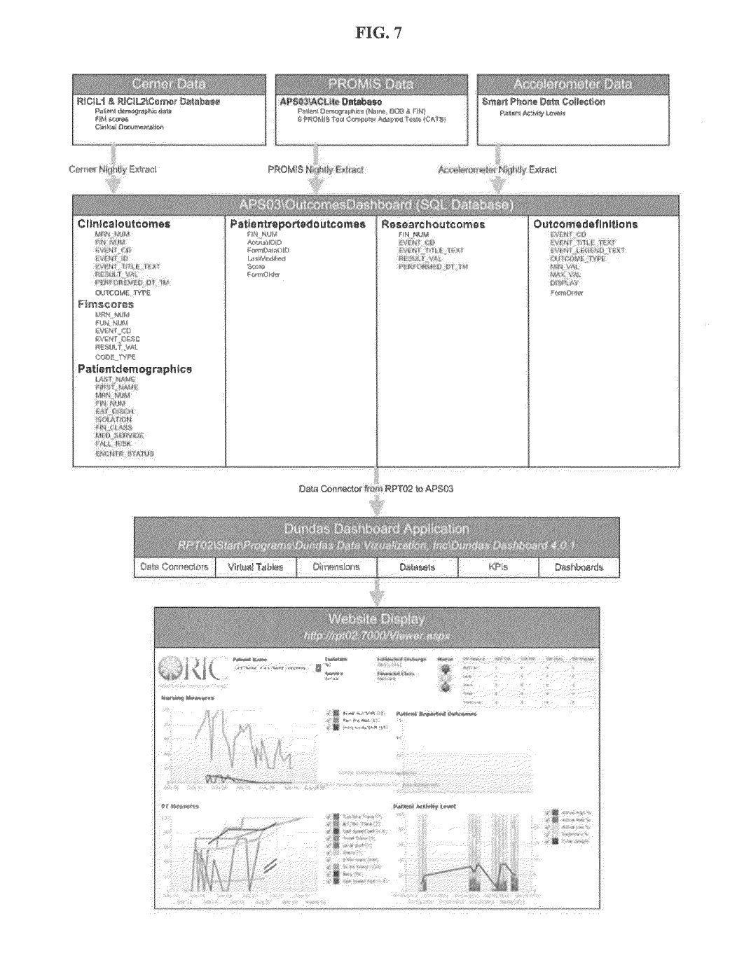

FIG. 7 displays the data structures used to collect and display data on embodiments of the dashboard system, and the flow of data from its initial storage in a database to its display on the rehabilitation dashboard. In one embodiment, clinical data collected during patient care is saved in one or more EMR databases, such as one or more Cerner databases. Such data includes, but is not limited to, patient demographic data, FIM scores, and clinical documentation. PROMIS or other patient-reported data may be collected in a patient-reported measures database. Accelerometer data, reflecting patient activity levels, may be collected in an accelerometer measures database. The data from these underlying databases may be collected on a periodic basis, such as every night, into an intermediate Outcomes Dashboard database, and organized to reflect a patient's clinical outcomes, FIM scores, patient demographics, patient reported outcomes, and research outcomes. The Outcomes Dashboard database may also include a table for listing outcome definitions, including the minimum and maximum values for each outcome in order to normalize that outcome. The dashboard application utilizes a data connector to take data from the Outcomes Dashboard database and present it for display to on the rehabilitation dashboard, at a user's request. In one embodiment, the rehabilitation dashboard software is stored on and executed by a server or other computing device having a memory, a processor, and optionally data input and output devices known in the field (such as a display, a keyboard, and a mouse). This computing device is connected to a computing network, such as a public network like the Internet or a private network such as a LAN, in order for it to communicate with other computing devices in order to receive and transmit information related to the rehabilitation dashboard. The databases described herein may be stored on separate computing devices or on the same computing device, or a combination thereof.

The embodiments of the present disclosure described herein are implemented as logical steps in one or more computer systems. The logical operations of the present disclosure are implemented (1) as a sequence of processor-implemented steps executing in one or more computer systems and (2) as interconnected machine or circuit engines within one or more computer systems. The implementation is a matter of choice, dependent on the performance requirements of the computer system implementing aspects of the present disclosure. Accordingly, the logical operations making up the embodiments of the disclosure described herein are referred to variously as operations, steps, objects, or engines. Furthermore, it should be understood that logical operations may be performed in any order, unless explicitly claimed otherwise or a specific order is inherently necessitated by the claim language.

It should be understood that the embodiments described herein do not rely on dashboard programs from a particular software provider or a particular computer platform to implement the dashboard system, and that any dashboard software or computer platform with similar features could be utilized to realize embodiments of the rehabilitation dashboard disclosed herein.

What is claimed is:

1. A computer-implemented dashboard system, comprising:
a main outcomes page for displaying rehabilitation outcomes information on a display associated with a computing device,
wherein the main outcomes page is configured to separate the rehabilitation outcomes information by two or more of the following categories of clinical discipline: medicine, nursing, physical therapy, occupational therapy, or speech language pathology.

2. The system of claim 1, where the rehabilitation outcome information comprises patient-reported outcomes information.

3. The system of claim 1, where the rehabilitation outcome information comprises patient activity level information.

4. The system of claim 3, where the patient activity level information is provided by an accelerometer worn or otherwise used by a patient.

5. The system of claim 1, where the rehabilitation outcomes information comprises admission information that is collected at about the time of a patient admission to a health care facility and current information that is collected after the collection of the admission set of information.

6. The system of claim 1, wherein at least a portion of the rehabilitation outcomes information is normalized.

7. The system of claim 1, wherein the rehabilitation outcomes information comprises the name of one or more outcomes measurements and a corresponding value reflecting a patient score in that measurement.

8. The system of claim 1, wherein the system is further configured to color code at least a portion of the rehabilitation outcomes information for display on the main outcomes page to reflect different levels of patient improvement.

9. The system of claim 1, where the system is further configured to display a progress indicator on the main outcomes page to indicate whether a patient is making appropriate progress in one or more areas.

10. The system of claim 1, where the system is further configured not to display on the main outcomes page the name of an outcomes measure that does not have a corresponding value reflecting a patient score in that measurement.

11. The system of claim 1, further comprising one or more detail outcomes pages for displaying rehabilitation outcomes information of a single clinical discipline.

12. The system of claim 11, wherein the system is further configured to provide at least one hyperlink on the main outcomes page to display one of the detail outcomes pages.

13. The system of claim 2, wherein the patient-reported outcomes information comprises PROMIS information.

14. The system of claim 4, wherein the patient activity level information comprises one or more values reflecting the amount of time in a day a patient has spent in one or more activity levels.

15. The system of claim 1, wherein at least a portion of the rehabilitation outcomes information is provided by one or more electronic medical record databases and one or more patient-reported measures databases.

16. The system of claim 15, wherein at least a portion of the rehabilitation outcomes information is provided by one or more accelerometer measures databases.

17. The system of claim 16, wherein system is further configured to store the rehabilitation outcomes information provided by the one or more electronic medical record databases, the one or more patient-reported measures databases, and the one or more accelerometer measures databases on a periodic basis in an intermediate database.

18. The system of claim 1, wherein a portion of the system is executed on a server computing device for communication with one or more databases of outcomes information and wherein the main outcomes page is configured to be displayed on a mobile computing device.

19. The system of claim 1, wherein the system is configured for the main outcomes page to display information related to a patient's participation in a research study.

20. A method, comprising:
receiving rehabilitation outcomes information from one or more databases; and
displaying the rehabilitation outcomes information on a display associated with a computing device;
wherein the display of the rehabilitation outcomes information is separated by two or more of the following categories of clinical discipline: medicine, nursing, physical therapy, occupational therapy, or speech language pathology.
